(19) United States
(12) Patent Application Publication
(10) Pub. No.: US 2006/0288681 A1
(43) Pub. Date: Dec. 28, 2006

(54) Vertical pivoting arm apparatus for offset towing

(76) Inventor: Daniel Kuzub, Regina (CA)

Correspondence Address: Daniel Kuzub, 201-2921 Harding Street, Regina, SK, S4V189, CA

(21) Appl. No.: 11/150,765

(22) Filed: Jun. 10, 2005

(51) Int. Cl. A01D 34/00

(52) U.S. Cl. 56/14.9

(57) ABSTRACT

An offset hitch apparatus includes a primary arm pivotally attached at an inner end thereof to the tractor about a primary axis aligned with the-tractor. A secondary arm is pivotally attached at an inner end thereof to an outer end of the primary arm about a secondary axis parallel to the primary axis. The primary arm pivots in a first plane located between a second plane in which the secondary arm pivots and the tractor. An implement attachment frame with wheels is pivotally attached to an outer end of the secondary arm about an implement pivot axis oriented parallel to the primary pivot axis. The primary arm pivots about the primary axis to move the implement attachment frame in or out. A driveline includes a drive shaft aligned with each pivot axis and links connecting the drive shafts.

This invention is in the field of towed implements, and in particular an apparatus for towing such implements along a path offset from the towing vehicle.

### BACKGROUND

It is desirable with some implements to tow the implement along a path offset from the path of the towing vehicle, typically a tractor. Such a configuration allows the tractor to travel a more desirable path along a road, for example, while the implement follows a less desirable path along a slope, such as a road ditch. Rotary cutters for example can thus travel along the sloped ditch while the tractor towing the cutter travels more safely on the relatively level road surface.

Offset hitches for towing an implement, such as a rotary cutter, along a path laterally offset from the tractor are disclosed for example in U.S. Pat. No. 5,957,475 to Pearen et al. and U.S. Pat. No. 6,739,612 to Colistro.

The Pearen apparatus comprises a frame mounted on fixed wheels with a tractor hitch arm extending forward from the front of the inside end of the frame for attachment to the tractor drawbar, and a cutter hitch at the rear of the opposite outer end of the frame for attachment to a cutter. A conventional cutter is attached to the cutter hitch of the apparatus as if it was the tractor drawbar. The result is the cutter travels a path offset to the one side of the tractor. The degree of offset can be changed by pivoting the arm about a vertical axis with respect to the frame.

The Colistro apparatus comprises a frame mounted on castering wheels, and the cutter is mounted to the frame such that the cutter and frame are laterally fixed and such that the rigid rear wheels of the cutter maintain the cutter traveling on the offset path. Again the degree of offset is changed by pivoting a forward extending tractor hitch arm about a vertical axis with respect to the frame.

U.S. Pat. No. 6,854,250 to Boyko discloses an offset rotary cutter apparatus having a tractor hitch arm pivotally mounted at a rear outside end thereof to the cutter deck about a vertical axis. Pivoting the arm with respect to the cutter varies the degree of offset.

Back-hoe type arm arrangements for maneuvering rotary mowers are also known, for example as disclosed in U.S. Pat. No. 4,869,056 to Lynch, U.S. Pat. No. 5,375,398 to McClymonds, U.S. Pat. No. 5,511,368 to Kocher, and U.S. Pat. No. 5,537,808 to Dallman. The back-hoe arms allow movement to either side of the tractor.

The above prior offset hitch mechanisms often place the implement at a considerable distance behind the towing vehicle or tractor, and same thus move laterally a significant amount with respect to the tractor during turns. In addition driving the mower or like implement on the end of the mechanisms is problematic, since numerous gearboxes, universal joints, and the like are required. In addition to being costly to build and maintain, these also result in uneven rotational speeds at the implement. As a result, implements requiring a drive are commonly powered by hydraulics instead of a more efficient mechanical drive.

### SUMMARY OF THE INVENTION

It is an object of the present invention to provide an apparatus for towing implements along a path that is offset from the path of a towing vehicle that overcomes disadvantages of the prior art.

In a first embodiment the present invention provides an apparatus for attaching an implement to a tractor such that the implement travels along an implement path offset from a vehicle path traveled by the tractor. The apparatus comprises a primary arm adapted to be pivotally attached at an inner end thereof to the tractor about a primary pivot axis oriented substantially horizontally and substantially in alignment with an operating travel direction of the tractor such that the primary arm can pivot in a first plane. A secondary arm is pivotally attached at an inner end thereof to an outer end of the primary arm about a secondary pivot axis oriented substantially parallel to the primary pivot axis such that the secondary arm can pivot in a second plane substantially parallel to the first plane. The first plane is located between the second plane and the tractor when the primary arm is attached to the tractor. An implement attachment frame is supported on the ground by at least one wheel and is pivotally attached to an outer end of the secondary arm about an implement pivot axis oriented substantially parallel to the primary pivot axis, and includes an implement hitch adapted for attachment of an implement to the implement attachment frame. A primary arm control is operative to pivot the primary arm about the primary pivot axis from a lowered position extending laterally outward from one side of the tractor, upward to a raised position such that the implement attachment frame moves along the ground toward the primary pivot axis.

The invention provides, in a second embodiment, a tractor and offset implement apparatus comprising a primary arm pivotally attached at an inner end thereof to a tractor about a primary pivot axis oriented substantially horizontally and substantially in alignment with an operating travel direction of the tractor such that the primary arm can pivot in a first plane. A secondary arm is pivotally attached at an inner end thereof to an outer end of the primary arm about a secondary pivot axis oriented substantially parallel to the primary pivot axis such that the secondary arm can pivot in a second plane substantially parallel to the first plane. The first plane is located between the second plane and the tractor. An implement is supported on the ground by at least one wheel and is pivotally attached to an outer end of the secondary arm about an implement pivot axis oriented substantially parallel to the primary pivot axis. A primary arm control is operative to pivot the primary arm about the primary pivot axis from a lowered position extending laterally outward from one side of the tractor, upward to a raised position such that the implement attachment frame moves along the ground toward the primary pivot axis.

The invention provides, in a third embodiment, an apparatus for attaching an implement to a tractor such that the implement travels along an implement path offset from a vehicle path traveled by the tractor. The apparatus comprises a primary arm adapted to be pivotally attached at an inner end thereof to the tractor about a primary pivot axis oriented substantially horizontally and substantially in alignment with an operating travel direction of the tractor such that the primary arm can pivot in a first plane. A secondary arm is pivotally attached at an inner end thereof to an outer end of the primary arm about a secondary pivot axis oriented substantially parallel to the primary pivot axis such that the secondary arm can pivot in a second plane substantially parallel to the first plane. The first plane is located between the second plane and the tractor when the primary arm is attached to the tractor. An implement attachment frame is supported on the ground by at least one wheel and is pivotally attached to an outer end of the secondary arm about an implement pivot axis oriented substantially parallel to the primary pivot axis, and includes an implement hitch adapted for attachment of an implement to the implement attachment frame. A primary arm control is operative to pivot the primary arm about the primary pivot axis from a lowered right position extending laterally outward from one side of the tractor, upward to a raised position such that the implement attachment frame moves along the ground toward the primary pivot axis. A secondary arm control is operative to pivot the secondary arm about the secondary pivot axis. An implement drive extends along the primary and secondary arms from the inner end of the primary arm to the implement attachment frame, and is adapted at an inner end thereof for connection to a power source on the tractor and is adapted at an outer end thereof for connection to a drive input of an implement.

The apparatus can be configured such that the implement can be moved to either side of the tractor, and can be mounted to a front or rear of the tractor.

The offset hitch apparatus of the invention thus provides a pair of arms that pivot about horizontal axes aligned with the operating travel direction of the tractor in parallel slightly separated vertical planes. The implement attached to the end of the arms closely follows the tractor, which term is used herein to indicate whatever towing vehicle might be used. The implement is more positively controlled by the tractor than implements in the prior art where the implement pivoted about a vertical axis. An improved mechanical drive line without universal joints can be readily provided as well. The aligned pivot axes of the apparatus provide convenient locations for linked drive shafts where the links are not affected by the position of the arms with respect to each other.

### DESCRIPTION OF THE DRAWINGS

While the invention is claimed in the concluding portions hereof, preferred embodiments are provided in the accompanying detailed description which may be best understood in conjunction with the accompanying diagrams where like parts in each of the several diagrams are labeled with like numbers, and where:

FIG. 1 is a schematic rear view of a two tractors, each with the same embodiment of the offset hitch apparatus of the invention mounted on the rear end thereof, and showing the primary and secondary arms;

FIG. 2 is a schematic rear view of the apparatuses of FIG. 1 with the arms partially moved to opposite sides;

FIG. 3 is a schematic rear view of the apparatuses of FIG. 1 with the arms fully extended to opposite sides;

FIGS. 4-6 are schematic top views of the apparatuses of FIG. 1 in respectively left, center, and right offset positions;

FIG. 7 is a schematic top sectional view of the embodiment of FIG. 1 with the arms in an aligned vertical position;

FIG. 8 is a schematic top view showing an offset hitch apparatus mounted on the front end of a tractor;

FIGS. 9-11 are schematic rear views of three embodiments of a primary arm control;

FIGS. 12-16 are schematic rear views illustrating the operation of an embodiment of a secondary arm control;

FIGS. 17 and 18 are schematic top and rear views of an embodiment of a driveline where the drive links are provided by belts;

FIGS. 19 and 20 are schematic top and rear views of an embodiment of a driveline where the drive links are provided by chains;

FIGS. 21 and 22 are schematic top and rear views of an embodiment of a driveline where the drive links are provided by rotating shafts driven by gearboxes.

### DETAILED DESCRIPTION OF THE ILLUSTRATED EMBODIMENTS

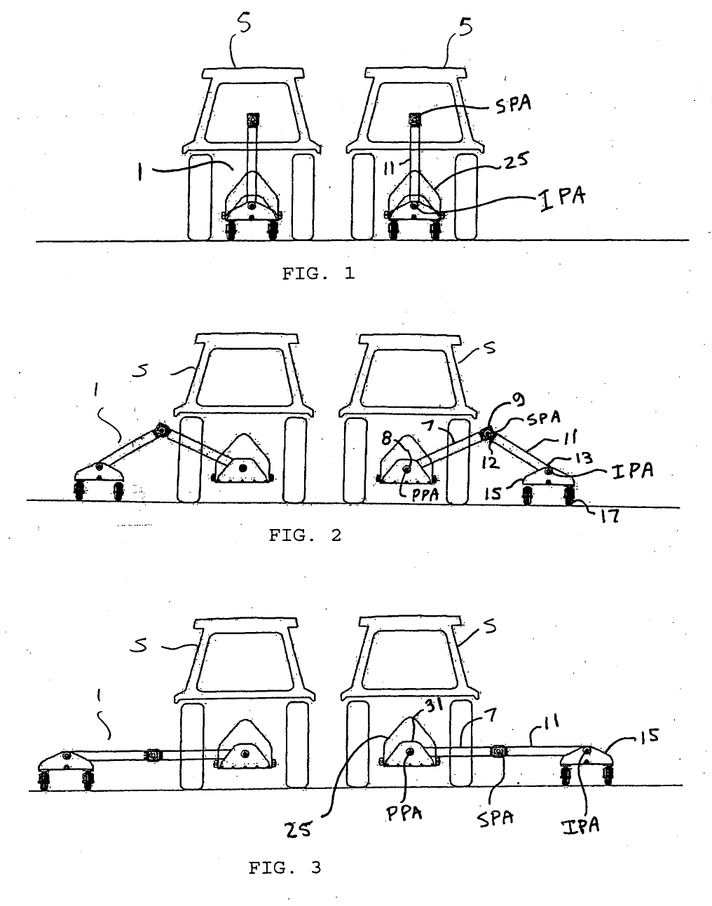

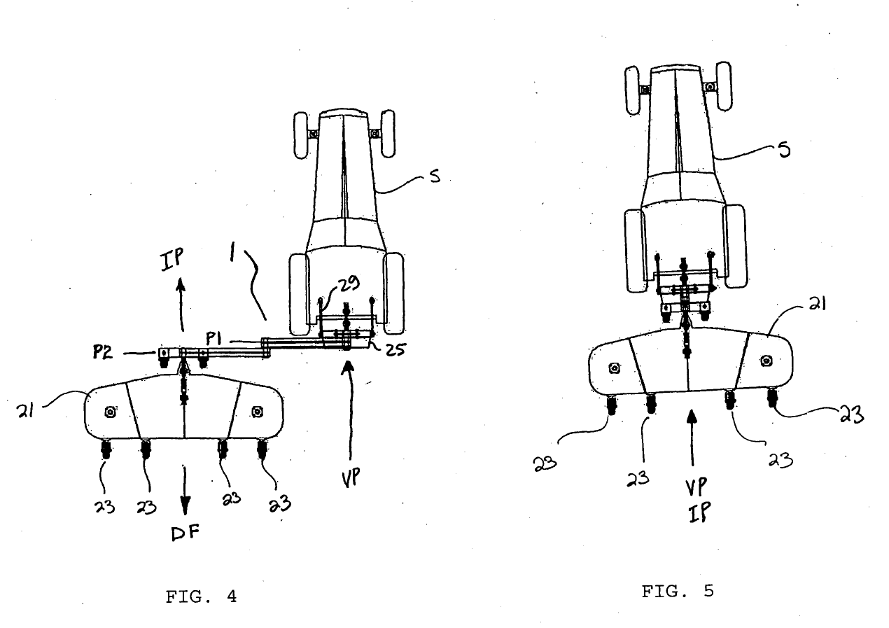

FIGS. 1-6 illustrate an offset hitch apparatus 1 of the invention for attaching an implement, such as a mower 3 as illustrated in FIGS. 4-6, to a tractor 5 such that the implement can travel, as illustrated in FIGS. 4 and 6, along an implement path IP offset from a vehicle path VP traveled by the tractor 5. FIGS. 1-3 show a pair of identical tractors 5 and attached offset hitch apparatuses 1, with the apparatus 1 on the right moving to a right offset position and the apparatus 1 on the left moving to a left offset position.

The apparatus 1 comprises a primary arm 7 adapted to be pivotally attached at an inner end 8 thereof to the tractor 5 about a primary pivot axis PPA oriented substantially horizontally and substantially in alignment with an operating travel direction VP of the tractor 5 such that the primary arm 7 can pivot in a first plane P1. A secondary arm 11 is pivotally attached at an inner end 12 thereof to an outer end 9 of the primary arm 7 about a secondary pivot axis SPA oriented substantially parallel to the primary pivot axis PPA such that the secondary arm 11 can pivot in a second plane P2 substantially parallel to the first plane. As illustrated the first plane PI is located between the second plane P2 and the tractor 5, such that the secondary arm 11 can move across behind the primary arm 7.

An implement attachment frame 15 is supported on the ground by a pair of wheels 17 and is pivotally attached to an outer end 13 of the secondary arm 1 1 about an implement pivot axis IPA oriented substantially parallel to the primary pivot axis PPA. The implement attachment frame 15 includes an implement hitch 19 adapted for attachment of an implement such as a mower 21 as illustrated in FIG. 6. Alternatively it may be desired to make a machine for use with a single implement, without the requirement of providing for attachment to various implements. A mower or like implement could then be designed to be pivotally attached directly to the outer end 13 of the secondary arm 7 about the implement pivot axis IPA.

The pivotal connections at primary pivot axis PPA, secondary pivot axis SPA, and implement pivot axis IPA are laterally substantially rigid such that when the mower 21 is traveling an implement path IP offset from the vehicle path VP of the tractor, it is maintained in that path against the drag force DF exerted on the arms 7, 11 by the mower 21 traveling over the ground.

A primary arm control 31 is operative to pivot the primary arm 7 about the primary pivot axis PPA from a lowered position extending laterally outward from one side of the tractor 5, as illustrated in FIG. 3, upward to a raised position as illustrated in FIG. 2 such that the implement attachment frame 15 moves along the ground toward the primary pivot axis PPA and closer to the tractor 5. Typically the wheels 17 supporting the implement attachment frame 17 will be caster wheels so that this lateral movement is facilitated. The rear wheels 23 of the mower 21 or like implement can also be caster wheels.

It is contemplated that fixed rear wheels 23, and even fixed wheels 17 supporting the implement attachment frame, could provide satisfactory service in some applications where quick and relatively precise manipulation of the implement is not required. When the tractor 5 is moving and the primary arm 7 is raised or lowered, the wheels 17, 23 can be dragged sideways somewhat. This movement can be facilitated by maneuvering the tractor 5 to make a turn tending to move the mower 21 in the desired direction.

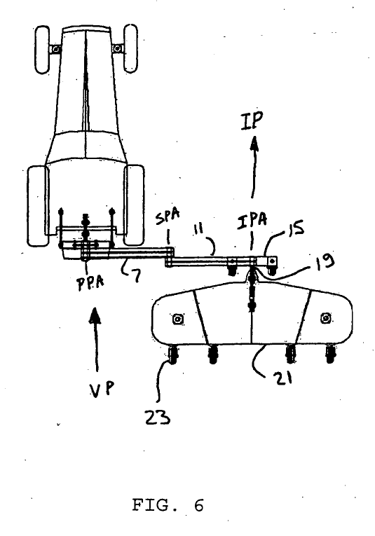

While in many applications it will be desired to shift the implement only to one side of the tractor 5, the apparatus 1 of the present invention is readily configured to provide a range of implement movement from one side to the opposite side. In the illustrated embodiments, the primary arm control 31 is operative to pivot the primary arm 7 about the primary pivot axis PPA from a lowered left position extending laterally outward from a left side of the tractor 5, as illustrated in FIG. 4 upward through a vertical position illustrated in FIG. 5 and then downward to a lowered right position extending laterally outward from a right side of the tractor 5 as illustrated in FIG. 6. The implement attachment frame 15 thus moves along the ground from a position on an implement path IP offset to the left side of the tractor 5, to a position on an implement path IP aligned with the vehicle path VP of the tractor 5 that is ideal for transport, to a position on an implement path IP offset to the left side of the tractor.

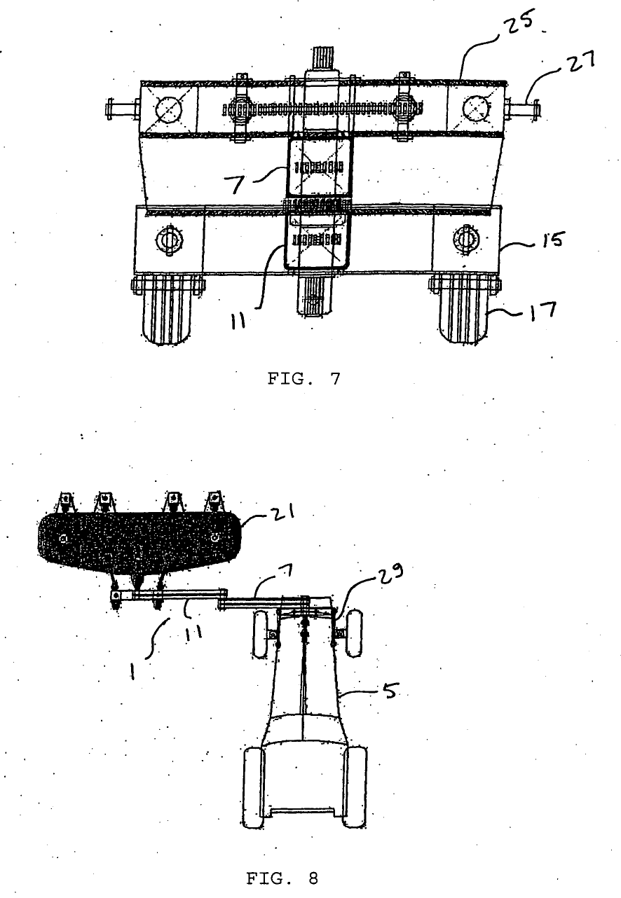

While it is contemplated that the apparatus 1 could be mounted to the tractor 5 in a variety of ways, in the illustrated embodiments the apparatus 1 comprises a tractor hitch frame 25, as illustrated also in FIG. 7, adapted to be attached to either the rear end of the tractor 5, or the front end of the tractor 5 as illustrated in FIG. 8. Attachment is conveniently by the conventional three point hitch 29 commonly available on tractors, often on both the front and rear ends of the tractor. The three point hitch attaches to hitch pins 27 extending from the tractor hitch frame 25. The inner end 8 of the primary arm 7 is pivotally attached to the tractor hitch frame 25 about the primary pivot axis PPA. When the arms 7, 11 are aligned in the vertical position of FIG. 5 the arms of the three point hitch 29 can be raised if desired to lift the implement off its wheels for transport.

Various embodiments of the primary arm control 31 are illustrated in FIGS. 9-11 where the primary arm control 31 comprises a circular primary member 33 fixed to the primary arm 7 such that a center of the primary member 33 coincides with the primary pivot axis PPA. An actuator 35 is then operative to rotate the primary member 33 to pivot the primary arm 7 about the primary pivot axis PPA.

In FIG. 9 the circular primary member 33 of the primary arm control 3 1A is provided by a primary sprocket 33A. The actuator 35 comprises a pair of extendable actuators 41 attached at lower ends thereof to the tractor hitch frame 25 and oriented such that the extendable actuators 41 are substantially parallel and the primary sprocket 33A is located between the extendable actuators 41. An actuator sprocket 43 is rotatably mounted to a top end of each extendable actuator 41 about rotational axes substantially parallel to the primary pivot axis PPA. A primary control chain 45 engages the primary sprocket 33A and the actuator sprockets 43 and an actuator control is operative to extend and retract the extendable actuators 41, typically hydraulic cylinders, to rotate the primary sprocket 33A to pivot the primary arm 7 about the primary pivot axis PPA.

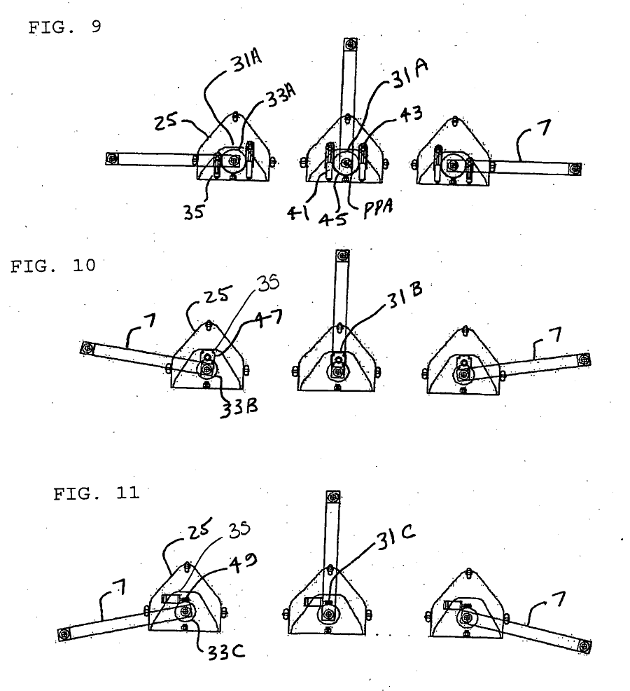

In the embodiment of FIG. 10 the circular primary member of the primary arm control 31B is provided by a primary gear 33B, and the actuator 35 comprises a spur drive gear 47 engaging the primary gear 33B and a motor operative to rotate the spur drive gear 47 and thus the primary gear 33B to pivot the primary arm 7.

In the embodiment of FIG. 11 the circular primary member of the primary arm control 31C is provided by a primary gear 33C, and the actuator 35 comprises a worm drive gear 49 engaging the primary gear 33C and a motor operative to rotate the worm drive gear 49 and thus the primary gear 33C to pivot the primary arm 7.

It is contemplated that the operation of the offset hitch apparatus 1 can be improved by further providing a secondary arm control 51, such as is illustrated in FIGS. 12-14, that is operative to pivot the secondary arm 11 about the secondary pivot axis SPA. Where no secondary arm control 51 is provided, the secondary arm 11 is allowed to freely pivot about the secondary pivot axis SPA and the secondary arm 11 floats between the implement attachment frame 15 riding along the ground on wheels 17, and the outer end 9 of the primary arm 7. When the primary arm 7 is pivoted one way or the other, the implement attachment frame will follow. In such an embodiment of the invention, if the arms 7, 11 are configured such that same may be moved to the aligned vertical position it will be required to provide some initial outward force on the implement attachment frame 15 to ensure that the apparatus falls into the desired configuration with the secondary arm 11 extending outward from the end of the primary arm 7. Without such a force the outer end of the primary arm 7 could simply move down and out over the secondary arm 11, leaving the implement attachment frame 15 behind the tractor.

A secondary arm control 51 could be provided by hydraulic cylinders or like actuators, especially where operation to one side of the tractor only is required. The illustrated secondary arm control 51 however provides control where operation to both sides of the tractor is required. Where the attached implement and the implement attachment frame 15 are supported on caster wheels and thus freely able to move sideways, the apparatus 1 with a secondary arm control 51 can be used to positively move the implement outward and inward to conveniently and accurately maneuver around trees or like obstacles.

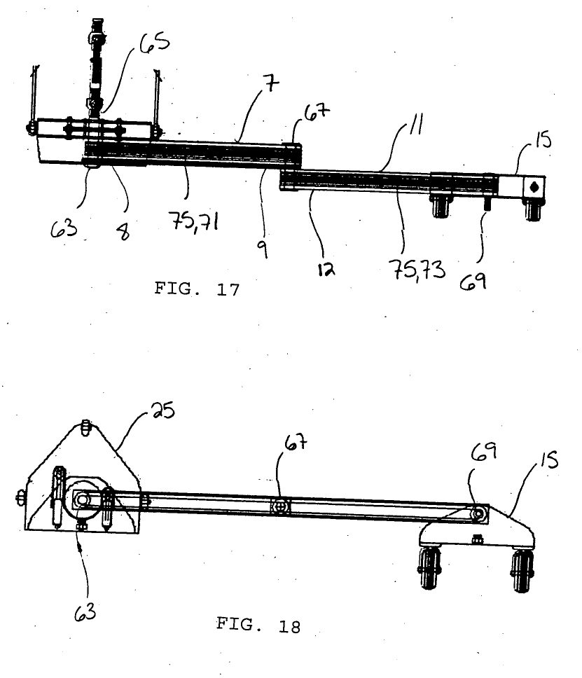

In the illustrated embodiment, the secondary arm control 51 is coordinated with the primary arm control 31 such that when the primary arm 7 is moved toward one side of the tractor, the secondary arm 11 moves toward the same side of the tractor. The secondary arm control 51 is also operative to substantially rigidly maintain the secondary arm 11 in alignment with the primary arm 7 when the primary arm 7 is oriented vertically, as illustrated in FIG. 15 and still allows a range of movement of the secondary arm 11 with respect to the primary arm 7 when the primary arm is extended to one side, as illustrated in FIGS. 12, 13, 14, and 16. Thus the apparatus 1 may be transported with the implement directly aligned with the tractor and substantially rigidly maintained in the aligned position, and when the arms 7, 11 are extended the secondary arm 11 can float with respect to the primary arm 7 to follow the ground.

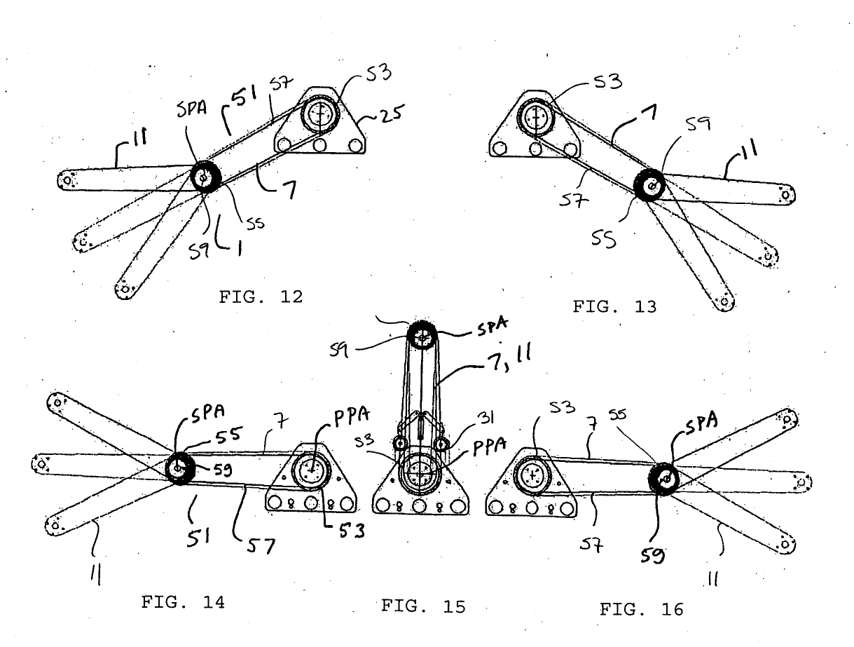

In the illustrated embodiment the secondary arm control 51 comprises a fixed sprocket 53 fixed to the tractor hitch frame 25 such that a center of the fixed sprocket 53 coincides with the primary pivot axis PPA. A secondary sprocket 55 is fixed to the secondary arm 11 and a secondary control chain 57 engages the fixed sprocket 53 and the secondary sprocket 55. To provide a range of movement, the center 59 of the secondary sprocket 55 is offset from the secondary pivot axis SPA as illustrated. The secondary sprocket 55 thus rotates eccentrically, such that when the primary arm 7 is oriented vertically, as in FIG. 15, the perimeter of the secondary sprocket 55, and thus the chain 57, moves away from the fixed sprocket 53 and the secondary control chain 57 is tight. When the primary arm 7 is extended to one side the perimeter of the secondary sprocket 55 moves toward the fixed sprocket 53 and the chain 57 loosens, allowing the secondary arm 11 to float with respect to the primary arm 7 as illustrated. FIGS. 12 and 13 illustrate as well that the primary arm 7 can move below the horizontal position for operation on slopes and the like if required.

The apparatus 1 can also conveniently and efficiently provide an implement drive connected to a power source on the tractor 5 adjacent to the inner end 8 of the primary arm 7 extending along the primary and secondary arms 7, 11 to the implement attachment frame 15 where the drive is adapted at an outer end thereof for connection to a drive input of an implement. The implement drive could be provided by hydraulic conduits adapted at an inner end thereof for connection to a hydraulic power source on the tractor and adapted at an outer end thereof for connection to a hydraulic motor on an implement. These conduits could be flexible and simply attached to the arms 7 and 11. A more efficient mechanical drive however can also conveniently be incorporated into the apparatus 1 by providing rotating drive shafts rotatably mounted such that their rotational axes are coincidental with the pivot axes. Thus the pivotal orientation of the arms 7, 11 will not affect the drive shafts, or move them with respect to each other, and same can be linked to rotate together to transfer power from the tractor to the implement.

A mechanical implement drive 61 is schematically illustrated in FIGS. 17-22. A primary drive shaft 63 is rotatably mounted to the tractor hitch frame 25 and inner end 8 of the 20 primary arm 7 such that a rotational axis of the primary drive shaft 63 coincides with the primary pivot axis PPA. The primary drive shaft 63 is adapted for connection to a power output shaft of the tractor, typically by a power take off shaft 65 connected to the conventional power take off of the tractor.

A secondary drive shaft 67 is rotatably mounted to the outer end 9 of the primary arm 7 and to the inner end 12 of the secondary arm 11 such that a rotational axis of the secondary drive shaft 67 coincides with the secondary pivot axis SPA. An implement drive shaft 69 is rotatably mounted to the implement attachment frame 15 and outer end of the secondary arm 11 such that a rotational axis of the implement drive shaft 69 coincides with the implement pivot axis IPA. The implement drive shaft 69 is adapted for connection to the drive input of an implement.

A primary drive link 71 connects the primary drive shaft 63 to the secondary drive shaft 67, and a secondary drive link 73 connects the secondary drive shaft 67 to the implement drive shaft 69 thus forming a driveline extending along the primary and secondary arms 7, 11 such that rotation of the primary drive shaft 63 causes rotation of the secondary drive shaft 67 and the implement drive shaft 69.

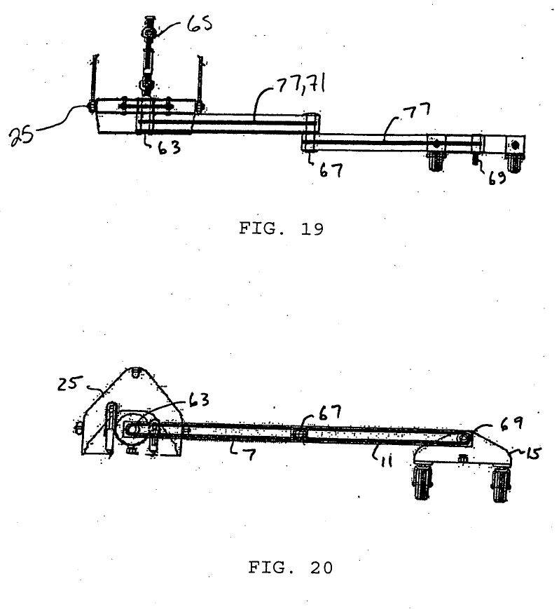

In FIGS. 17 and 18, the drive links comprise belts 75 with appropriate pulleys mounted on the shafts, 63, 67, 69. In FIGS. 19 and 20, the drive links comprise chains 77 with appropriate sprockets mounted on the shafts, 63, 67, 69.

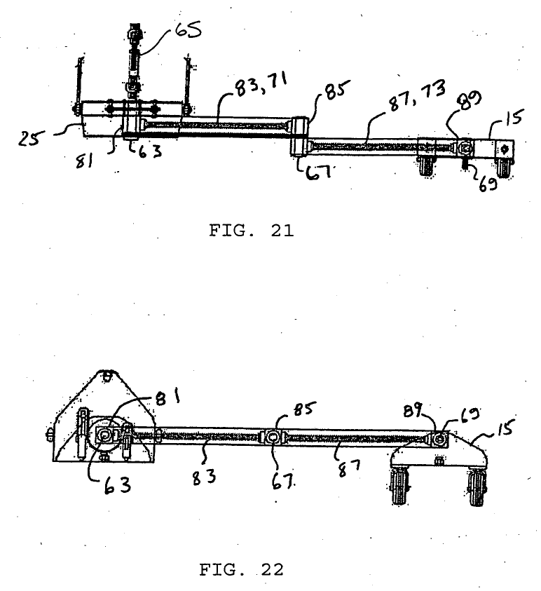

In the embodiment of FIGS. 21 and 22 a right angle primary gearbox 81 is driven by the primary drive shaft 63. A primary arm shaft 83 provides the primary drive link 71 and is driven by the primary gearbox 81. A double secondary gearbox 85 is driven by the primary arm shaft and drives the secondary drive shaft 67 and thus drives a secondary arm shaft 87 providing the secondary drive link 73 and an implement gearbox 89 is driven by the secondary arm shaft 87 and drives the implement drive shaft 69.

In the illustrated embodiment the links 71, 73 are illustrated as passing through the arms 7, 11 which are provided by tubular members. Those skilled in the art will recognize that same could also be mounted exterior to arms made from alternate materials.

The offset hitch apparatus 1 of the invention thus provides a pair of arms 7, 11 that pivot about horizontal axes aligned with the operating travel direction of the tractor in parallel slightly separated vertical planes P1 and P2. The implement attached to the end of the arms closely follows the tractor, which term is used herein to indicate whatever towing vehicle might be used. The implement is more positively controlled by the tractor than implements in the prior art where the implement pivoted about a vertical axis. An improved mechanical drive line without universal joints can be readily provided as well. The aligned pivot axes of the apparatus provide convenient locations for linked drive shafts where the links are not affected by the position of the arms with respect to each other.

The foregoing is considered as illustrative only of the principles of the invention. Further, since numerous changes and modifications will readily occur to those skilled in the art, it is not desired to limit the invention to the exact construction and operation shown and described, and accordingly, all such suitable changes or modifications in structure or operation which may be resorted to are intended to fall within the scope of the claimed invention.

1. An apparatus for attaching an implement to a tractor such that the implement travels along an implement path offset from a vehicle path traveled by the tractor, the apparatus comprising:
a primary arm adapted to be pivotally attached at an inner end thereof to the tractor about a primary pivot axis oriented substantially horizontally and substantially in alignment with an operating travel direction of the tractor such that the primary arm can pivot in a first plane;
a secondary arm pivotally attached at an inner end thereof to an outer end of the primary arm about a secondary pivot axis oriented substantially parallel to the primary pivot axis such that the secondary arm can pivot in a second plane substantially parallel to the first plane;
wherein the first plane is located between the second plane and the tractor when the primary arm is attached to the tractor;
an implement attachment frame supported on a ground surface by at least one wheel and pivotally attached to an outer end of the secondary arm about an implement pivot axis oriented substantially parallel to the primary pivot axis, and including an implement hitch adapted for attachment of an implement to the implement attachment frame; and
a primary arm control operative to pivot the primary arm about the primary pivot axis from a lowered position extending laterally outward from one side of the tractor, upward to a raised position such that the implement attachment frame moves toward the primary pivot axis.

2. The apparatus of claim 1 wherein the primary arm control is operative to pivot the primary arm about the primary pivot axis from a lowered right position extending laterally outward from a right side of the tractor, upward through a vertical position and then downward to a lowered left position extending laterally outward from a left side of the tractor such that the implement attachment frame moves from a position on the right side of the tractor to a position on the left side of the tractor.

3. The apparatus of claim 2 further comprising a secondary arm control operative to pivot the secondary arm about the secondary pivot axis.

4. The apparatus of claim 3 wherein the secondary arm control is coordinated with the primary arm control such that when the primary arm is moved toward one side of the tractor, the secondary arm moves toward the same side of the tractor.

5. The apparatus of claim 4 wherein the secondary arm control is operative to substantially rigidly maintain the secondary arm in alignment with the primary arm when the primary arm is oriented vertically, and wherein the secondary arm control is operative to allow a range of movement of the secondary arm with respect to the primary arm when the primary arm is extended to one side.

6. The apparatus of claim 5 comprising a tractor hitch frame adapted to be attached to one of a front end and a rear end of the tractor, and wherein the inner end of the primary arm is pivotally attached to the tractor hitch frame about the primary pivot axis.

7. The apparatus of claim 6 wherein the primary arm control comprises:
a circular primary member fixed to the primary arm such that a center of the primary member coincides with the primary pivot axis; and
an actuator operative to rotate the primary member to pivot the primary arm about the primary pivot axis.

8. The apparatus of claim 7 wherein the secondary arm control comprises:
a fixed sprocket fixed to the tractor hitch frame such that a center of the fixed sprocket coincides with the primary pivot axis; and
a secondary sprocket fixed to the secondary arm and a secondary control chain engaging the fixed sprocket and the secondary sprocket, wherein a center of the secondary sprocket is offset from the secondary pivot axis such that when the primary arm is oriented vertically the secondary control chain is tight, and such that when the primary arm is extended to one side the secondary control chain loosens.

9. The apparatus of claim 7 wherein the circular primary member is provided by a primary sprocket, and wherein the actuator comprises:
a pair of extendable actuators attached at lower ends thereof to the tractor hitch frame and oriented such that the extendable actuators are substantially parallel and such that the primary sprocket is located between the extendable actuators;
an actuator sprocket rotatably mounted to a top end of each extendable actuator about rotational axes substantially parallel to the primary pivot axis;
a primary control chain engaging the primary sprocket and the actuator sprockets; and
an actuator control operative to extend and retract the pair of extendable actuators to rotate the primary sprocket to pivot the primary arm about the primary pivot axis.

10. The apparatus of claim 7 wherein the circular primary member is provided by a primary gear, and wherein the actuator comprises a drive gear engaging the primary gear and a motor operative to rotate the drive gear.

11. The apparatus of claim 1 further comprising an implement drive extending along the primary and secondary arms from the inner end of the primary arm to the implement attachment frame, and adapted at an inner end thereof for connection to a power source on the tractor and adapted at an outer end thereof for connection to a drive input of the implement.

12. The apparatus of claim 11 wherein the implement drive comprises hydraulic conduits adapted at an inner end thereof for connection to a hydraulic power source on the tractor and adapted at an outer end thereof for connection to a hydraulic motor on the implement.

13. The apparatus of claim 11 wherein the implement drive comprises:
a tractor hitch frame adapted to be attached to one of a front end and a rear end of the tractor, and wherein the inner end of the primary arm is pivotally attached to the tractor hitch frame about the primary pivot axis;
a primary drive shaft rotatably mounted to the tractor hitch frame and inner end of the primary arm such that a rotational axis of the primary drive shaft coincides with the primary pivot axis, wherein the primary drive shaft is adapted for connection to a power output shaft of the tractor;
an implement drive shaft rotatably mounted to the implement attachment frame and outer end of the secondary arm such that a rotational axis of the implement drive shaft coincides with the implement pivot axis, wherein the implement drive shaft is adapted for connection to the drive input of the implement; and
a driveline extending along the primary and secondary arms such that rotation of the primary drive shaft causes rotation of the implement drive shaft.

14. The apparatus of claim 13 wherein the driveline comprises:
a secondary drive shaft rotatably mounted to the outer end of the primary arm and to the inner end of the secondary arm such that a rotational axis of the secondary drive shaft coincides with the secondary pivot axis;
a primary drive link connecting the primary drive shaft to the secondary drive shaft; and
a secondary drive link connecting the secondary drive shaft to the implement drive shaft.

15. The apparatus of claim 14 wherein at least one drive link comprises one of a chain and a belt.

16. The apparatus of claim 14 comprising:
a primary gearbox driven by the primary drive shaft;
a primary arm shaft providing the primary drive link and driven by the primary gearbox;
a secondary gearbox driven by the primary arm shaft and driving the secondary drive shaft;
a secondary arm shaft providing the secondary drive link and driven by the secondary drive shaft; and
an implement gearbox driven by the secondary arm shaft and driving the implement drive shaft.

17. A tractor and offset implement apparatus comprising:
a primary arm pivotally attached at an inner end thereof to a tractor about a primary pivot axis oriented substantially horizontally and substantially in alignment with an operating travel direction of the tractor such that the primary arm can pivot in a first plane;
a secondary arm pivotally attached at an inner end thereof to an outer end of the primary arm about a secondary pivot axis oriented substantially parallel to the primary pivot axis such that the secondary arm can pivot in a second plane substantially parallel to the first plane;
wherein the first plane is located between the second plane and the tractor;
an implement supported on a ground surface by at least one wheel and pivotally attached to an outer end of the secondary arm about an implement pivot axis oriented substantially parallel to the primary pivot axis; and
a primary arm control operative to pivot the primary arm about the primary pivot axis from a lowered position extending laterally outward from one side of the tractor, upward to a raised position such that the implement attachment frame moves along the ground surface toward the primary pivot axis.

18. The apparatus of claim 17 wherein the primary arm control is operative to pivot the primary arm about the primary pivot axis from a lowered right position extending laterally outward from a right side of the tractor, upward through a vertical position and then downward to a lowered left position extending laterally outward from a left side of the tractor such that the implement attachment frame moves along the ground surface from a position on the right side of the tractor to a position on the left side of the tractor.

19. The apparatus of claim 18 further comprising a secondary arm control operative to pivot the secondary arm about the secondary pivot axis.

20. The apparatus of claim 19 wherein the secondary arm control is coordinated with the primary arm control such that when the primary arm is moved toward one side of the tractor, the secondary arm moves toward the same side of the tractor.

21. The apparatus of claim 20 wherein the secondary arm control is operative to substantially rigidly maintain the secondary arm in alignment with the primary arm when the primary arm is oriented vertically, and wherein the secondary arm control is operative to allow a range of movement of the secondary arm with respect to the primary arm when the primary arm is extended to one side.

22. The apparatus of claim 21 comprising a tractor hitch frame attached to one of a front end and a rear end of the tractor, and wherein the inner end of the primary arm is pivotally attached to the tractor hitch frame about the primary pivot axis.

23. The apparatus of claim 22 wherein the primary arm control comprises:
a circular primary member fixed to the primary arm such that a center of the primary member coincides with the primary pivot axis; and
an actuator operative to rotate the primary member to pivot the primary arm about the primary pivot axis.

24. The apparatus of claim 23 wherein the secondary arm control comprises:
a fixed sprocket fixed to the tractor hitch frame such that a center of the fixed sprocket coincides with the primary pivot axis; and
a secondary sprocket fixed to the secondary arm and a secondary control chain engaging the fixed sprocket and the secondary sprocket, wherein a center of the secondary sprocket is offset from the secondary pivot axis such that when the primary arm is oriented vertically the secondary control chain is tight, and such that when the primary arm is extended to one side the secondary control chain loosens.

25. The apparatus of claim 17 further comprising an implement drive extending along the primary and secondary arms from the inner end of the primary arm to the implement and connected at an inner end thereof to a power source on the tractor and connected at an outer end thereof to a drive input of the implement.

26. The apparatus of claim 25 wherein the implement drive comprises:
a primary drive shaft rotatably mounted to the inner end of the primary arm such that a rotational axis of the primary drive shaft coincides with the primary pivot axis, wherein the primary drive shaft is connected to a power output shaft of the tractor;
a secondary drive shaft rotatably mounted to the outer end of the primary arm and to the inner end of the secondary arm such that a rotational axis of the secondary drive shaft coincides with the secondary pivot axis;
an implement drive shaft rotatably mounted to the outer end of the secondary arm such that a rotational axis of the implement drive shaft coincides with the implement pivot axis, wherein the implement drive shaft is connected to the drive input of the implement;
a primary drive link connecting the primary drive shaft to the secondary drive shaft; and
a secondary drive link connecting the secondary drive shaft to the implement drive shaft.

27. The apparatus of claim 26 wherein at least one drive link comprises one of a chain and a belt.

28. The apparatus of claim 26 comprising:
a primary gearbox driven by the primary drive shaft;
a primary arm shaft providing the primary drive link and driven by the primary gearbox;
a secondary gearbox driven by the primary arm shaft and driving the secondary drive shaft;
a secondary arm shaft providing the secondary drive link and driven by the secondary drive shaft; and
an implement gearbox driven by the secondary arm shaft and driving the implement drive shaft.

29. An apparatus for attaching an implement to a tractor such that the implement travels along an implement path offset from a vehicle path traveled by the tractor, the apparatus comprising:
a primary arm adapted to be pivotally attached at an inner end thereof to the tractor about a primary pivot axis oriented substantially horizontally and substantially in alignment with an operating travel direction of the tractor such that the primary arm can pivot in a first plane;
a secondary arm pivotally attached at an inner end thereof to an outer end of the primary arm about a secondary pivot axis oriented substantially parallel to the primary pivot axis such that the secondary arm can pivot in a second plane substantially parallel to the first plane;
wherein the first plane is located between the second plane and the tractor when the primary arm is attached to the tractor;
an implement attachment frame supported on a ground surface by at least one wheel and pivotally attached to an outer end of the secondary arm about an implement pivot axis oriented substantially parallel to the primary pivot axis, and including an implement hitch adapted for attachment of an implement to the implement attachment frame;
a primary arm control operative to pivot the primary arm about the primary pivot axis from a lowered position extending laterally outward from one side of the tractor, upward to a raised position such that the implement attachment frame moves toward the primary pivot axis;
a secondary arm control operative to pivot the secondary arm about the secondary pivot axis; and
an implement drive extending along the primary and secondary arms from the inner end of the primary arm to the implement attachment frame, and adapted at an inner end thereof for connection to a power source on the tractor and adapted at an outer end thereof for connection to a drive input of an implement.

30. The apparatus of claim 29 wherein the primary arm control is operative to pivot the primary arm about the primary pivot axis from a lowered right position extending laterally outward from a right side of the tractor, upward through a vertical position and then downward to a lowered left position extending laterally outward from a left side of the tractor such that the implement attachment frame moves from a position on the right side of the tractor to a position on the left side of the tractor.

31. The apparatus of claim 29 wherein the implement drive comprises
a tractor hitch frame adapted to be attached to one of a front end and a rear end of the tractor, and wherein the inner end of the primary arm is pivotally attached to the tractor hitch frame about the primary pivot axis;
a primary drive shaft rotatably mounted to the tractor hitch frame and inner end of the primary arm such that a rotational axis of the primary drive shaft coincides with the primary pivot axis, wherein the primary drive shaft is adapted for connection to a power output shaft of the tractor;
a secondary drive shaft rotatably mounted to the outer end of the primary arm and to the inner end of the secondary arm such that a rotational axis of the secondary drive shaft coincides with the secondary pivot axis;
an implement drive shaft rotatably mounted to the implement attachment frame and outer end of the secondary arm such that a rotational axis of the implement drive shaft coincides with the implement pivot axis, wherein the implement drive shaft is adapted for connection to the drive input of an implement;
a primary drive link connecting the primary drive shaft to the secondary drive shaft; and a secondary drive link connecting the secondary drive shaft to the implement drive shaft.
